(19) United States
(12) Patent Application Publication
(10) Pub. No.: US 2011/0151392 A1
(43) Pub. Date: Jun. 23, 2011

(54) SYSTEM OF TUBE, RESIN AND STOPS FOR ORTHODONTICS

(76) Inventor: Joaquin T. Ariza, Colombia (CO)

(21) Appl. No.: 13/035,871

(22) Filed: Feb. 25, 2011

Related U.S. Application Data
(63) Continuation of application No. 12/548,407, filed on Aug. 26, 2009.

(51) Int. Cl. A61C 7/24

(52) U.S. Cl. 433/17

(57) ABSTRACT

The present invention provides an orthodontics system that comprises the tube, resin, stops, and wire, wherein the system allows for standardization of the resin and tube, according e.g., to each tooth, either by means of a prefabricated set of resin and tube or by making the resin with the tube during the orthodontics treatment session. The present invention also allows for the use of several kinds of wire. In addition, the use of the tube of the present invention results in less friction. Furthermore, the use of one stop, or a plain stop and a hooked stop concomitantly, allows for application of localized torsion force to specific teeth. Moreover, the side effects decreased significantly when the tubes and the system of the present invention are used.

### FIELD OF THE INVENTION

This Application is a continuation in part of U.S. patent application Ser. No. 12/548,407 filed on Aug. 26, 2009, which has the same inventor in common. U.S. patent application Ser. No. 12/548,407 is incorporated herein in its entirety by reference.

### FIELD OF THE INVENTION

The field of the invention relates to dental orthodontics systems used to fix teeth positions and to correct anomalies of maxillary function derived from teeth incorrect positions, wherein a wire is used to correct tooth position.

### DESCRIPTION OF PRIOR ART

Orthodontic treatment has been generally used to reposition misaligned teeth whether for cosmetic or structural reasons. In these treatments, teeth move through the use of force which is currently carried out by means of appliances known as brackets which are connected by a wire, this structure is generally known as braces. Typical braces include a number of pieces such as brackets, bands, arch-wires, ligatures, and O-rings. Various patent applications have been filed around novel characteristics for orthodontic treatments (see US2008/0248442 by Raby, Richard and PCT/US2007/067259 by Mclaughlin, Richard et al.).

However, orthodontic treatments using braces have shown a number of drawbacks related with uncomfortable feeling of patient, problems to feed, increase of mouth illnesses and aesthetic problems. Patients under orthodontic treatments develop particular gestures due to the unpleasant feeling of the brackets in the mouth; moreover, several side effects have been reported like lacerations on oral cavity mucosa, increase of accumulation of dental bacterial plaque, which can lead to dental cavities or periodontal problems such as gingivitis.

In addition to the uncomfortable feeling and mouth health problems derived from braces, patients also report various aesthetic problems. Having a metal complex structure in the mouth dramatically changes the appearance of a patient affecting his/her look and their relationships because of the difficulties for kissing.

Colombian Patent Application No. 06.083.244 by Ariza, Joaquin relates to an orthodontic system for teeth alignment without brackets. The application by Ariza describe an orthodontic system using resin instead of brackets. However, the use of resin and wire is hard to standardize and limits the kind of wires that can be used. In addition, there is high friction between the wire and the resin.

The present invention provides a device and a system with significant fewer side effects, easy to standardize, considerably less friction, and with many more options in relation to the kind of wires that can be used.

### SUMMARY OF THE INVENTION

The present invention an orthodontics system that comprises the tube, resin, stops, and wire, wherein the system allows for standardization of the resin and tube, according e.g., to each tooth, either by means of a prefabricated set of resin and tube or by making the resin with the tube during the orthodontics treatment session. The present invention also allows for the use of several kinds of wire. In addition, the use of the tube of the present invention results in less friction. Furthermore, the use of one stop, or a plain stop and a hooked stop concomitantly, allows for application of localized torsion force to specific teeth. Moreover, the side effects decreased significantly when the tubes and the system of the present invention are used.

Specifically, the present invention provides a system of orthodontics, wherein said system comprises:
A. At least one tube;
B. At least one resin, wherein the resin surrounds the tube, and wherein the resin attaches to a tooth;
C. At least one wire, wherein the wire goes throughout the tube;
D. At least one plain stop;

Wherein the system is used on either, the anterior side or the posterior side of teeth, and wherein there is one tube surrounded by one resin on one surface of one tooth, and wherein the wire goes throughout all the tubes on the anterior side or the posterior side of the teeth of one maxilla, and wherein the stop will halt the lateral displacement of the wire

In one aspect of the system of the present invention, the resin and tube assembly is prefabricated.

In another aspect of the system of the present invention, the resin and tube assembly is made at the moment is put on the tooth.

In one more aspect of the system of the present invention, the system further comprises an additional hooked stop, wherein the concomitant presence of both, the plain stop and the hooked stop allows for application of localized torsion force to an specific tooth.

Objectives and additional advantages of the present invention will become more evident in the detailed description of the invention and the claims.

### BRIEF DESCRIPTION OF THE DRAWINGS

FIG. 1 shows the system of the present invention applied to teeth of a maxilla.

FIG. 2 shows the system of the present invention applied to teeth of a maxilla.

FIG. 3 shows a plain stop and the a pair of hooked stops (with a left and a right hook) of the system of the present invention.

FIG. 4 shows several embodiments of the tube of the present invention.

### DETAILED DESCRIPTION OF THE INVENTION

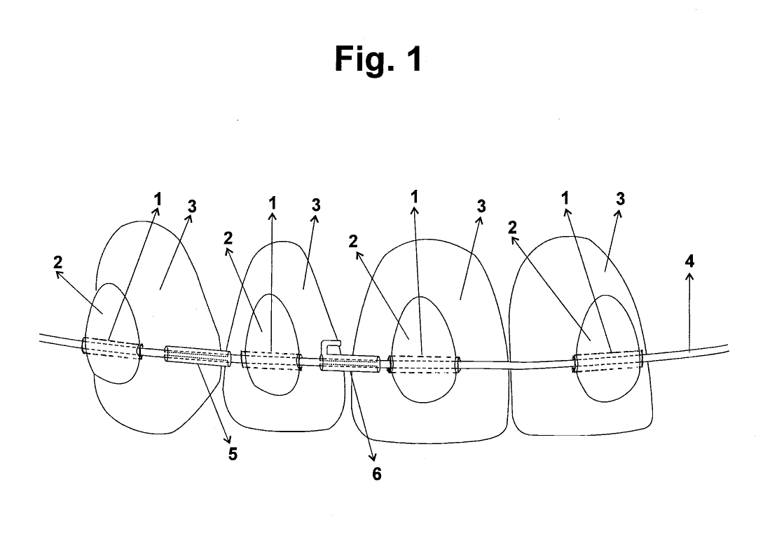

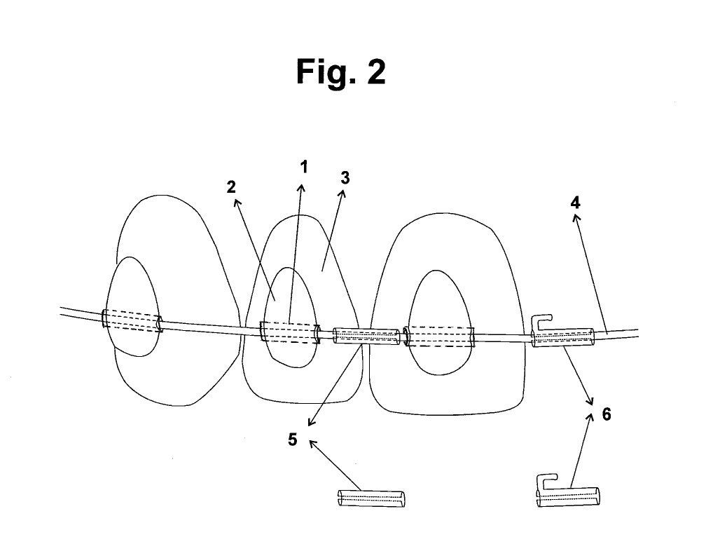

The present invention provides a system of orthodontics, wherein said system comprises:
A. At least one tube (1) (FIGS. 1 and 2);
B. At least one resin (2) (FIGS. 1 and 2), wherein the resin (2) surrounds the tube (1), and wherein the resin (2) attaches to a tooth (3) (FIGS. 1 and 2);
C. At least one wire (4) (FIGS. 1 and 2), wherein the wire (4) goes throughout the tube (1);
D. At least one plain stop (5) (FIGS. 1-3);

Wherein the system is used on either, the anterior side or the posterior side of teeth, and wherein there is one tube surrounded by one resin on one surface of one tooth, and wherein the wire goes throughout all the tubes on the anterior side or the posterior side of the teeth of one maxilla, and wherein the stop will halt the lateral displacement of the wire.

The tube is preferably metallic; however the tube can be made of any appropriate hard material such as carbon, polymeric compounds, hard plastics, etc.

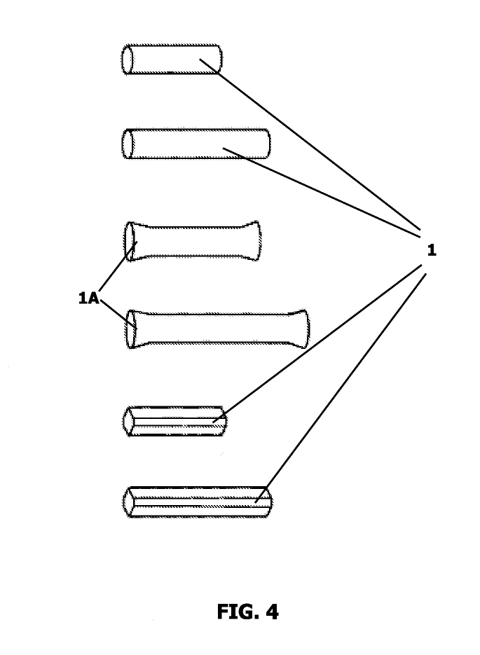

The tube is defined as a hollow device with an internal space and openings at both ends, wherein the hollow internal space serves as a conduit for a wire. Said tube preferably has a hollow cylindrical form; however the definition of tube also includes any appropriate geometrical form, e.g., oval, square with rounded corners, rectangular, pentagonal, hexagonal, etc (1) (FIG. 4). The geometric form of the tube could be in accordance with the arch to be used and the dental movement required. The tube definition also include a tube which may also have both ends with a bigger perimeter than the perimeter of the body (1A) (FIG. 4). A tube with tube ends with a bigger perimeter allows an improve fix within a resin.

For the purposes of this invention the term “resin” includes any kind of resin used in dentistry and/or other substitute appropriate materials that allow manipulation on teeth e.g., ceramics, polymeric materials, etc. Wherein the resin and/or substitute material preferably is of the same color as the teeth being treated. However, the term resin also includes a resin or substituted material of any color if chosen by the person who is being treated.

A specific assembly of resin or substitute material, and the tube can be prefabricated with specifications regarding shape and dimensions in accordance with a specific tooth and the surface of the tooth to which the system of resin and tube is being applied. The assembly of resin or substitute material and tube can also be made at the moment of application on a tooth.

The resin or substituted material of the present invention also has the characteristic of allowing manipulation (either prefabricated or made during treatment) to determine specific distances between the tube and the treated tooth as to compensate for the volumetric difference of some tooth and to correct tooth rotation.

The system of the present invention can be applied to the anterior side of inferior or superior maxilla teeth (the side oriented to the mouth lips), or to the posterior side (the side oriented to the palate or tongue of the mouth) of inferior or superior maxilla teeth.

On another aspect of the system of the present invention, the wire goes throughout all the tubes on either the anterior or the posterior side of the teeth of one maxilla.

The system of orthodontics of the present invention also provides a wire, wherein the definition of wire includes any kind of line or appropriate wire that is metallic made, or metallic alloy made, or nylon made, or carbon made, or polymer made, or plastic made, or any kind of fiber made, or synthetic made, or any combination of materials made, etc. Preferably the wire is made of an alloy of titanium, copper and nickel.

For purposes of the present invention, the term “plain stop” preferably refers to a tubular clamp similar to the one shown in (5) (FIGS. 1-3), wherein the plain stop will surround the wire at an specific portion of said wire, wherein the plain stop will be closed by mechanical pressure becoming fixed at said portion of the wire. The term “plain stop” may also refers to any kind of stops, e.g., crimp, crimpable, crowder, etc., used in the art of the invention. Crimp, crimpable and crowder stops are wide used terms used in the art of the invention.

In one aspect of the system of orthodontics of the present invention, the resin and tube assembly is prefabricated.

In another aspect of the system of orthodontics of the present invention, the resin and tube assembly is made at the moment is put on the tooth.

The resin, tube, and the assembly of resin and tube of the system of orthodontics of the present invention have all the characteristics already mentioned in any of the paragraphs of the present application.

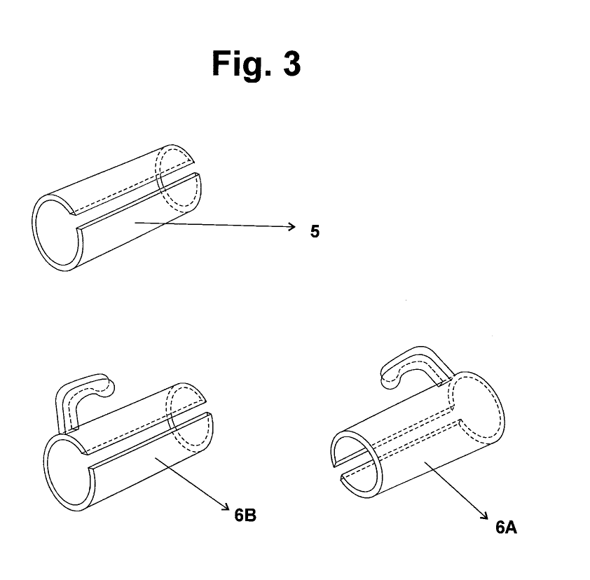

In one more aspect of the system of the present invention, the system further comprises an additional hooked stop (6) (FIGS. 1 and 2) (6A y 6B in FIG. 3, wherein 6A shows the right hooked tube and 6B the left hooked tube), wherein the concomitant presence of both, the plain (5) stop and the hooked stop (6) allows for application of localized torsion force to an specific tooth. The localized torsion force can be applied by anchoring the hooked stop with elastic elements.

For purposes of the present invention, the term “hooked stop” refers to a tubular clamp with a hook similar to the one shown in (6, 6A and 6B) (FIGS. 1-3), wherein the hooked stop will surround the wire at an specific portion of said wire, wherein the hooked stop will be closed by mechanical pressure becoming fixed at said portion of the wire. The term “hooked stop” may also refers to any kind of stops, e.g., crimp, crimpable, crowder, etc., with a hook, used in the art of the invention.

The tube, system of tube and resin, and system of orthodontics of the present invention can be adapted for the use of vertical tubes with horizontal support when there is a need to move the body of a tooth.

While the description presents the preferred embodiments of the present invention, additional changes can be made in the form and disposition of the parts without distancing from the basic ideas and principles comprised in the claims.

1. A system of orthodontics, wherein said system comprises:
A. At least one tube;
B. At least one resin, wherein the resin surrounds the tube, and wherein the resin attaches to a tooth;
C. At least one wire, wherein the wire goes throughout the tube;
D. At least one plain stop;
Wherein the system is used on one side of teeth, and wherein there is one tube surrounded by one resin on one surface of one tooth, and wherein the wire goes throughout all the tubes on one side of the teeth of one maxilla, and wherein the stop will halt the lateral displacement of the wire.

2. The system of claim 1, wherein the resin and tube assembly is prefabricated.

3. The system of claim 1, wherein the resin and tube assembly is made at the moment is put on the tooth.

4. The system of claim 1, wherein the system further comprises an additional hooked stop, wherein the concomitant presence of both, the plain stop and the hooked stop allows for application of localized torsion force to an specific tooth.
